(19) United States
(12) Patent Application Publication
(10) Pub. No.: US 2019/0049582 A1
(43) Pub. Date: Feb. 14, 2019

(54) INFORMATION PROCESSING DEVICE, CONTROL METHOD, PROGRAM AND STORAGE MEDIUM

(71) Applicant: PIONEER CORPORATION, Bunkyo-ku, Tokyo (JP)

(72) Inventors: Yukio HAYASHI, Saitama (JP); Yoshinori ABE, Saitama (JP)

(73) Assignee: PIONEER CORPORATION, Bunkyo-ku, Tokyo (JP)

(21) Appl. No.: 16/077,351

(22) PCT Filed: Feb. 12, 2016
(86) PCT No.: PCT/JP2016/054176

§ 371 Date: Aug. 10, 2018

(51) Int. Cl. G01S 17/10

(52) U.S. Cl. CPC G01S 17/10

(57) ABSTRACT

On the basis of a segment signal Sseg outputted by a core unit 1, a signal processing unit 2 of a LIDAR unit 100 generates a polar coordinate space frame Fp indicating the received light intensity of laser light with respect to each scan angle that indicates the outgoing direction of the laser light and its corresponding target distance Ltag. Then, the signal processing unit 2 converts the polar coordinate space frames Fp into an orthogonal coordinate space frame Fo and outputs it to a display control unit 3. Further, for an outgoing direction of the laser light in which the segment signal Sseg outputted by the core unit 1 indicates a received light intensity equal to or larger than a threshold Apth, the signal processing unit 2 generates the measurement point information Ip and outputs it to a point group processing unit 5.

### TECHNICAL FIELD

The present invention relates to a technology for ranging.

### BACKGROUND TECHNIQUE

Conventionally, there is known a method for measuring the distance to an object in the vicinity. For example, Patent Reference-1 discloses a LIDAR which detects a point group of the surface of an object by scanning the horizontal direction with intermittently emitted laser light and by receiving the reflected laser light.

Patent Reference-1: Japanese Patent Application Laid-open under No. 2014-106854

### DISCLOSURE OF INVENTION

### Problem to be Solved by the Invention

Generally, a conventional LIDAR detects the peak position of the received pulse with respect to each outgoing direction in the horizontal direction to thereby measure the distance based on the delay time to the peak position. Unfortunately, in such a case that the peak level of the received pulse is lower than or equivalent to the noise, however, it cannot properly detect the peak position and therefore it cannot detect a point group corresponding to an object situated in the distance. In contrast, when the output of a LIDAR is used for an environment recognition in the vicinity of a vehicle, a real-time detection of an object is required.

The above is an example of the problem to be solved by the present invention. An object of the present invention is to provide an information processing device capable of suitably outputting a ranging result of an object situated within the measuring range.

### Means for Solving the Problem

One invention is an information processing device including: an emitting unit configured to emit laser light while changing an outgoing direction of the laser light; a light receiving unit configured to receive the laser light reflected by an object; and an output unit configured, on a basis of a light receiving signal outputted by the light receiving unit, to (i) generate and output first information which indicates received light intensity of the laser light with respect to each of the outgoing direction and distance, in the corresponding outgoing direction, from a reference position relating to an emitting position, and (ii) generate and output, in the outgoing direction that the light receiving signal indicates a received light intensity equal to or higher than a predetermined value, second information which indicates distance to the object.

Another invention is a control method executed by an information processing device, the information processing device including an emitting unit and a light receiving unit, the emitting unit configured to emit laser light while changing an outgoing direction of the laser light, the light receiving unit configured to receive the laser light reflected by an object, the control method including an output process, on a basis of a light receiving signal outputted by the light receiving unit, to (i) generate and output fist information which indicates received light intensity of the laser light with respect to each of the outgoing direction and distance, in the corresponding outgoing direction, from a reference position relating to an emitting position, and (ii) generate and output, in the outgoing direction that the light receiving signal indicates a received light intensity equal to or higher than a predetermined value, second information which indicates distance to the object.

Still another invention is a program executed by a computer of an information processing device, the information processing device including an emitting unit and a light receiving unit, the emitting unit configured to emit laser light while changing an outgoing direction of the laser light, the light receiving unit configured to receive the laser light reflected by an object, the program making the computer function as an output unit configured, on a basis of a light receiving signal outputted by the light receiving unit, to (i) generate and output fist information which indicates received light intensity of the laser light with respect to each of the outgoing direction and distance, in the corresponding outgoing direction, from a reference position relating to an emitting position, and (ii) generate and output, in the outgoing direction that the light receiving signal indicates a received light intensity equal to or higher than a predetermined value, second information which indicates distance to the object.

### BRIEF DESCRIPTION OF THE DRAWINGS

FIG. 1 illustrates a schematic configuration of a LIDAR unit.

FIG. 2 illustrates a block diagram of a core unit.

FIG. 3 illustrates waveforms of a trigger signal and a segment extraction signal.

FIG. 4 illustrates a block configuration of a signal processing unit.

FIG. 5A illustrates a waveform of a segment signal.

FIG. 5B illustrates a waveform of a reference pulse.

FIG. 5C illustrates a waveform of a replica pulse.

FIG. 6 illustrates an overview of the subtraction process of the replica pulse.

FIG. 7 is a block diagram illustrating a functional configuration of a frame direction filtering portion.

FIG. 8 is a plane view schematically illustrating surroundings of the LIDAR unit.

FIG. 9A is a diagram in which the point group detected at the zeroth frame process is plotted on an orthogonal coordinate system.

FIG. 9B is a diagram in which the point group detected at the fifth frame process is plotted on the orthogonal coordinate system.

FIG. 10A is a diagram in which the point group detected at the tenth frame process is plotted on an orthogonal coordinate system.

FIG. 10B is a diagram in which the point group detected at the fifteenth frame process is plotted on the orthogonal coordinate system.

FIG. 11 is a display example of the orthogonal coordinate space frame in a case where the subtraction process by use of the replica pulse is not executed.

FIG. 12 is a display example of the orthogonal coordinate space frame in a case where the subtraction process by use of the replica pulse is executed.

FIG. 13 illustrates a block configuration of the signal processing unit according to a modification.

FIGS. 14A to 14C each illustrates a waveform of a signal relating to the subtraction process by use of the replica pulse.

### DETAILED DESCRIPTION OF THE PREFERRED EMBODIMENTS

According to a preferable embodiment of the present invention, an information processing device includes: an emitting unit configured to emit laser light while changing an outgoing direction of the laser light; a light receiving unit configured to receive the laser light reflected by an object; and an output unit configured, on a basis of a light receiving signal outputted by the light receiving unit, to (i) generate and output fist information which indicates received light intensity of the laser light with respect to each of the outgoing direction and distance, in the corresponding outgoing direction, from a reference position relating to an emitting position, and (ii) generate and output, in the outgoing direction that the light receiving signal indicates a received light intensity equal to or higher than a predetermined value, second information which indicates distance to the object.

The above information processing device includes an emitting unit, a light receiving unit and an output unit. The emitting unit is configured to emit laser light while changing an outgoing direction of the laser light. The light receiving unit is configured to receive the laser light reflected by an object. The term “object” herein indicates any object situated within a range which the laser light can reach. The output unit is configured to generate and output first information based on a light receiving signal outputted by the light receiving unit. The first information herein indicates received light intensity of the laser light with respect to each of the outgoing direction and distance, in the corresponding outgoing direction, from a reference position relating to an emitting position. The output unit may display the first information on a display by outputting the first information to the display or may output the first information to another processing unit. Furthermore, for such an outgoing direction that the light receiving signal indicates a received light intensity equal to or higher than a predetermined value, the output unit generates and outputs second information which indicates distance to the object based on the light receiving signal. The output unit may display the second information on a display by outputting the second information to the display or may output the second information to another processing unit. The second information may include not only information on the distance to the object but also information on the received light intensity. For example, in a case where the second information is outputted as a point group, the information on the received light intensity is converted into the reflection intensity after distance correction and is used for compartment line detection and the like.

According to this mode, the information processing device can output, as the second information, information on such a relatively near object that the received light intensity is equal to or higher than the predetermined value while outputting information on other objects as the first information.

In one mode of the information processing device, the output unit is configured to output time-averaged first information based on multiple pieces of the first information generated for a predetermined time length. According to this mode, the information processing device can generate and output such first information that the influence of the noise is suitably reduced.

In another mode of the information processing device, the output unit is configured to generate third information from the light receiving signal in the outgoing direction that the second information is generated, and the output unit is configured to generate the first information by subtracting a signal component of the third information from the light receiving signal outputted by the light receiving unit. Thereby, the information processing device can remove, from the first information, the third information generated from the light receiving signal in the emitting direction that the second information is generated.

In still another mode of the information processing device, the output unit is configured, with respect to each of the outgoing direction, to generate, as the third information, a signal having a peak with the same position and amplitude as a waveform of the light receiving signal in the outgoing direction that the second information is generated, the peak having an amplitude equal to or larger the predetermined value, and the output unit is configured to subtract the signal component of the third information from the light receiving signal in the corresponding outgoing direction. According to this mode, the information processing device can suitably remove, from the first information, the point group information of the object detected as the second information.

In still another mode of the information processing device, in a case where the peak is multiple, the output unit generates the third information with respect to each of the peak and subtracts each signal component of the third information from the light receiving signal in the corresponding outgoing direction. According to this mode, even at the time of detecting multiple peaks from the light receiving signal per outgoing direction due to the multipath of the laser light, the information processing device can output the first information with the precise removal of information on the multiple peaks.

In still another mode of the information processing device, the information processing device further includes a conversion unit configured to convert the first information outputted by the output unit to fourth information which indicates the received light intensity in an orthogonal coordinate system (i.e., coordinate system defined by two axes perpendicular to each other) corresponding to a plane irradiated with the laser light. Thereby, for example, the information processing device can convert the coordinates of the first information and output the converted first information so that a user can intuitively recognize the object.

In still another mode of the information processing device, the fourth information indicates the received light intensity in a two dimensional space which is parallel to a horizontal plane, and the information processing device further includes a display control unit configured to display an image based on the fourth information on a display unit. According to this mode, the information processing device can suitably let the user visually recognize the existence of objects in the vicinity.

According to another preferable embodiment of the present invention, there is provided a control method executed by an information processing device, the information processing device including an emitting unit and a light receiving unit, the emitting unit configured to emit laser light while changing an outgoing direction of the laser light, the light receiving unit configured to receive the laser light reflected by an object, the control method including an output process, on a basis of a light receiving signal outputted by the light receiving unit, to (i) generate and output fist information which indicates received light intensity of the laser light with respect to each of the outgoing direction and distance, in the corresponding outgoing direction, from a reference position relating to an emitting position, and (ii) generate and output, in the outgoing direction that the light receiving signal indicates a received light intensity equal to or higher than a predetermined value, second information which indicates distance to the object. By executing the above-mentioned control method, the information processing device can output, as the second information, information on such a relatively near object that the received light intensity is equal to or higher than the predetermined value while outputting information on other objects as the first information.

According to still another preferable embodiment of the present invention, there is provided a program executed by a computer of an information processing device, the information processing device including an emitting unit and a light receiving unit, the emitting unit configured to emit laser light while changing an outgoing direction of the laser light, the light receiving unit configured to receive the laser light reflected by an object, the program making the computer function as an output unit configured, on a basis of a light receiving signal outputted by the light receiving unit, to (i) generate and output fist information which indicates received light intensity of the laser light with respect to each of the outgoing direction and distance, in the corresponding outgoing direction, from a reference position relating to an emitting position, and (ii) generate and output, in the outgoing direction that the light receiving signal indicates a received light intensity equal to or higher than a predetermined value, second information which indicates distance to the object. By executing the above-mentioned program, the information processing device can output, as the second information, information on such a relatively near object that the received light intensity is equal to or higher than the predetermined value while outputting information on other objects as the first information. Preferably, the program can be treated in a state that it is stored in a storage medium.

### EMBODIMENT

Now, a preferred embodiment of the present invention will be described below with reference to the attached drawings.

[Entire Configuration]

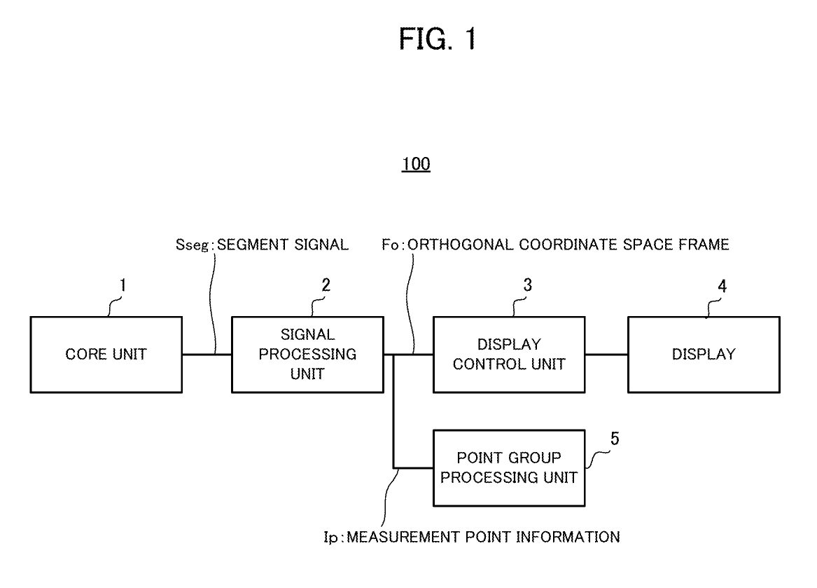

FIG. 1 illustrates a block configuration of a LIDAR unit 100 according to the embodiment. The LIDAR unit 100 illustrated in FIG. 1 is a LIDAR (Light Detection and Ranging, or Laser Illuminated Detection and Ranging) based on TOF (Time of Flight) and performs a 360-degree ranging of objects in a horizontal direction. For example, the LIDAR unit 100 is used for the purpose of an assistance of environment recognitions in the vicinity of a vehicle as a part of an advanced driving assistance system. The LIDAR unit 100 mainly includes a core unit 1, a signal processing unit 2, a display control unit 3, a display 4 and a point group processing unit 5. The LIDAR unit 100 is an example of the “information processing device” according to the present invention.

The core unit 1 emits pulse lasers at all directions equivalent to 360 degrees in the horizontal direction while gradually changing the outgoing direction of the pulse lasers. In this case, the core unit 1 emits a pulse laser per segment (out of 900 segments according to the embodiment) into which 360 degrees in the horizontal direction are evenly divided. Then, the core unit 1 supplies the signal processing unit 2 with a signal (referred to as “segment signal Sseg”) which indicates the received light intensity per segment measured by receiving a reflective light of the pulse laser within a predetermined duration after emitting the pulse laser.

The signal processing unit 2 detects a peak position of each waveform of the segment signal Sseg per segment received from the core unit 1. On the basis of the detected peak position, the signal processing unit 2 calculates the distance to the irradiation point (referred to as “measurement point”) on a target object of the laser irradiation. Then, the signal processing unit 2 supplies the point group processing unit 5 with information (referred to as “measurement point information Ip”) on measurement points each of which is a combination of the distance calculated per segment and the scanning angle at the corresponding segment.

Besides, the signal processing unit 2 generates two dimensional image (referred to as “polar coordinate space frame Fp”) in a polar coordinate space (polar coordinate system) by integrating the segment signals Sseg of all segments which are received from the core unit 1, wherein the polar coordinate space frame Fp indicates the relationship between each segment corresponding to each direction of 360 degrees in the horizontal direction and the corresponding distance from the LIDAR unit 100. Then, on the basis of the polar coordinate space frames Fp, the signal processing unit 2 generates a two dimensional image (referred to as “orthogonal coordinate space frame Fo”) in the orthogonal (Cartesian) coordinate system on the scan plate (irradiated plate) of pulse lasers and supplies the display control unit 3 therewith. In this case, as mentioned later, with respect to each segment, the signal processing unit 2 removes information on a group (simply referred to as “point group”) of detected measurement points from the segment signal Sseg before generating the polar coordinate space frame Fp. Thereby, the signal processing unit 2 prevents a relatively near object detected as a point group from being displayed on the orthogonal coordinate space frame Fo.

The display control unit 3 displays on the display 4 an image based on the orthogonal coordinate space frame Fo received from the signal processing unit 2. The point group processing unit 5 performs a process based on the measurement point information Ip sent from the signal processing unit 2. For example, the point group processing unit 5 performs a common environment recognition process based on the output of a LIDAR, an own position estimation process and/or display process on the display 4.

[Configuration of Core Unit]

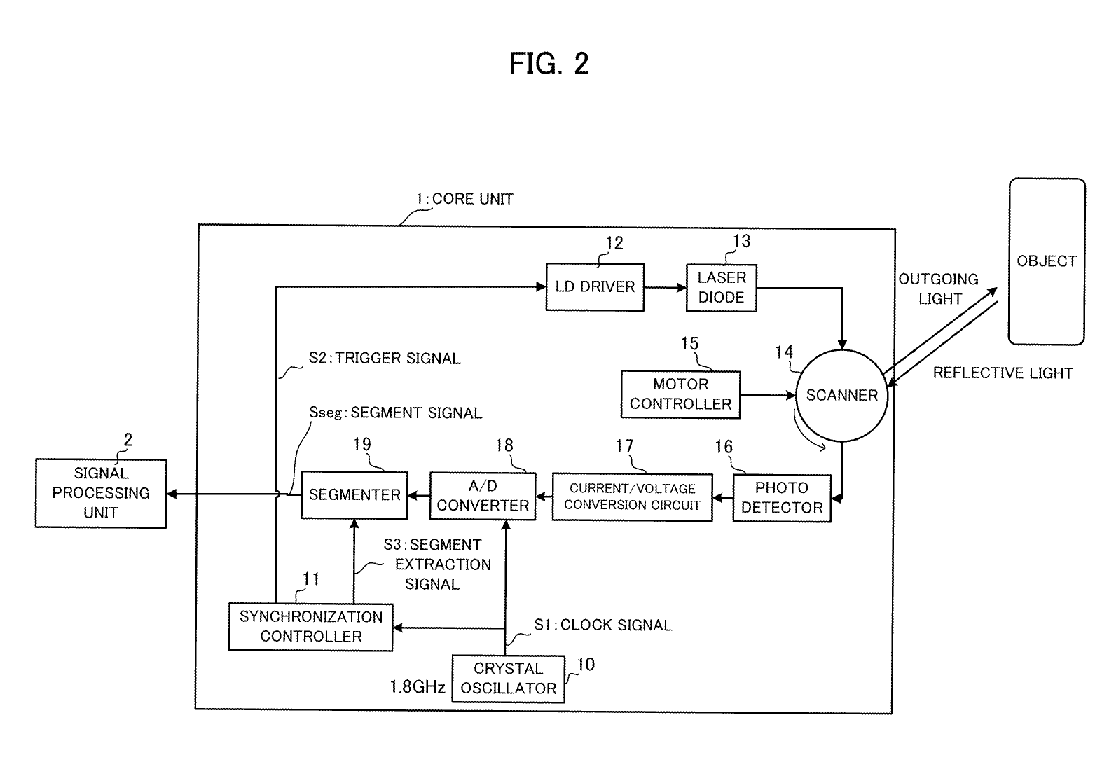

FIG. 2 illustrates an example of a schematic configuration of the core unit 1. As illustrated in FIG. 2, the core unit 1 mainly includes a crystal oscillator 10, a synchronization controller 11, a LD driver 12, a laser diode 13, a scanner 14, a motor controller 15, a photo detector 16, a current/voltage conversion circuit (Transimpedance Amplifier) 17, an A/D converter 18 and a segmenter 19.

The crystal oscillator 10 supplies the synchronization controller 11 and the A/D converter 18 with a pulsed clock signal “S1”. As an example, the clock frequency according to the embodiment is set to 1.8 GHz. Hereinafter, each clock based on the clock signal S1 is also referred to as “sample clock”.

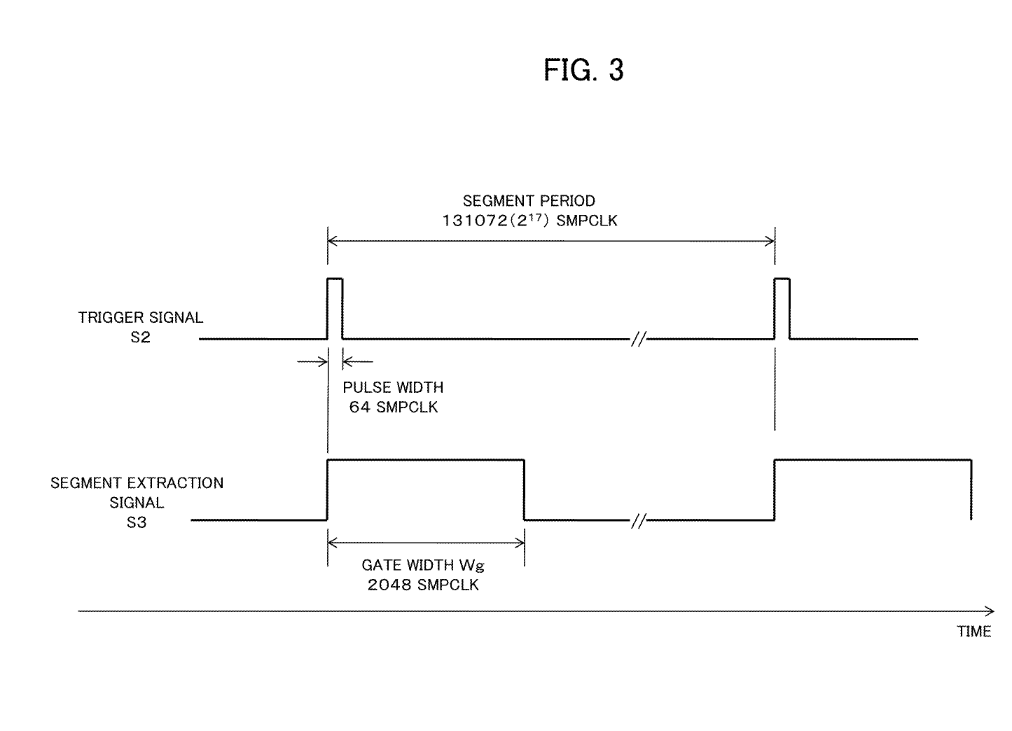

The synchronization controller 11 supplies the LD driver 12 with a pulsed signal (referred to as “trigger signal S2”). The trigger signal S2 according to the embodiment is periodically asserted at intervals of 131072 (=2¹⁷) sample clock. Hereinafter, a time period from timing of asserting the trigger signal S2 to the next timing of asserting the trigger signal S2 is referred to as “segment period”. The synchronization controller 11 supplies the segmenter 19 with a signal (hereinafter referred to as “segment extraction signal S3”) which determines the timing for the later-mentioned segmenter 19 to extract the output of the A/D converter 18. Each of the trigger signal S2 and the segment extraction signal S3 is a logic signal and they are synchronized with each other as illustrated in FIG. 3 to be mentioned later. According to the embodiment, the synchronization controller 11 asserts the segment extraction signal S3 for a time width (referred to as “gate width Wg”) equivalent to 2048 sample clocks.

The LD driver 12 supplies pulsed current to the laser diode 13 in synchronization with the trigger signal S2 inputted from the synchronization controller 11. For example, the laser diode 13 is an infrared pulse laser with the wavelength of 905 nm and emits pulses of light based on the pulsed current supplied from the LD driver 12. The laser diode 13 according to the embodiment emits each pulse of light for approximately five nano seconds.

The scanner 14 includes configurations of a transmission optical system and a receiving optical system. While scanning 360 degrees in the horizontal plane by use of pulses of light emitted from the laser diode 13, the scanner 14 leads, to the photo detector 16, the return light reflected at an object (referred to as “object”) that is irradiated with the pulses of emitted light. According to the embodiment, the scanner 14 includes a motor for revolving, and the motor is controlled by the motor controller 15 to revolve once every 900 segments. The angular resolution capability in this case is 0.4° (=360°/900) per segment. The LD driver 12 and the scanner 14 constitute an example of the “emitting unit” according to the present invention.

Preferably, the scan surface scanned by the scanner 14 is not an umbrella surface but a flat surface. Additionally, when the LIDAR unit 100 is mounted on a moving body, it is desirable for the scan surface to be in parallel (i.e., horizontal) with the land surface on which the moving body travels. This leads to a high correlation among polar coordinate space frames Fp which are successively generated in time series as described later, and therefore it is possible to precisely display the surrounding environment.

Examples of the photo detector 16 include an avalanche photodiode, and the photo detector 16 generates a slight current in accordance with the amount of the reflective light from the object through the scanner 14. The photo detector 16 supplies the generated slight current to the current/voltage conversion circuit 17. The current/voltage conversion circuit 17 amplifies the slight current supplied from the photo detector 16 to thereby convert it to a voltage signal and inputs the converted voltage signal to the A/D converter 18.

The A/D converter 18 converts, on the basis of the clock signal S1 supplied from the crystal oscillator 1 zero the voltage signal supplied by the current/voltage conversion circuit 17 to the digital signal, and thereafter the A/D converter 18 supplies the converted digital signal to the segmenter 19. Hereinafter, a digital signal which the A/D converter 18 generates per one clock is referred to as “sample”. One sample corresponds to one pixel data of the later-mentioned polar coordinate space frame Fp. The photo detector 16, the current/voltage conversion circuit 17 and the A/D converter 18 constitute an example of the “light receiving unit” according to the present invention.

The segmenter 19 generates a segment signal Sseg by extracting digital signals which the A/D converter 18 outputs during the time period when the segment extraction signal S3 is asserted for the gate width Wg equivalent to 2048 sample clocks. The segmenter 19 supplies the generated segment signal Sseg to the signal processing unit 2.

FIG. 3 illustrates time-series waveforms corresponding to the trigger signal S2 and the segment extraction signal S3. As illustrated in FIG. 3, according to the embodiment, a segment period that is one cycle of the trigger signal S2 being asserted is determined to have the length of 131072 sample clocks (referred to as “SMPCLK” in the drawings). The pulse width of the trigger signal S2 is determined to have the length of 64 sample clocks, and the gate width Wg is determined to have the length of 2048 sample clocks.

In this case, since the segment extraction signal S3 is asserted during the period of the gate width Wg after the trigger signal S2 is asserted, the segmenter 19 extracts 2048 samples outputted by the A/D converter 18 during the trigger signal S2 being asserted. The longer the gate width Wg is, the longer the maximum ranging distance (i.e., ranging limit distance) from the LIDAR unit 100 becomes.

According to the embodiment, the frequency in the segment period is approximately 13.73 kHz (that is nearly equal to 1.8 GHz/131072), and the frame frequency (i.e., rotational velocity of the scanner 14) of the polar coordinate space frame Fp generated based on the segment signal Sseg by the signal processing unit 2 is approximately 15.36 Hz (that is nearly equal to 13.73 kHz/900) considering that one frame is configured of 900 segments. When calculated simply, the maximum ranging distance is 170.55 m (that is nearly equal to {2048/1.8 GHz}·c/2; “c” stands for light speed) corresponding to the distance where light shuttles for a time length corresponding to the gate width Wg. As described later, the maximum ranging distance is slightly shorter than 170.55 m due to the later-described origin offset.

Hereinafter, a supplemental explanation will be given of the relationship between the delay time (referred to as “delay time Id”) of output and the distance (referred to as “target distance Ltag”) to the object, wherein the delay time is a time length between the timing of asserting a trigger signal S2 and the timing of outputting a sample which corresponds to the pulse of light outputted based on the asserted trigger signal S2.

On the assumption that “s” (s=0 to 899) is the index of the segments each corresponding to the scan angle of the scanner 14 and that “k” (k=0 to 2047) is the index of 2048 samples generated by the A/D converter 18 during the segment extraction signal S3 being asserted, the magnitude of the sample index k is in accordance with the target distance Ltag. Specifically, if the clock frequency is “fsmp” (=1.8 GHz) and electrical and optical delays are not considered, the relationship between the sample index k and delay time Td is expressed as

Td=k/fsmp≈k·0.55555 nsec.

In this case, if any delays are not considered, the relationship between the target distance Ltag and the delay time Td is expressed as

Ltag=Td·(c/2)=(k/fsmp)·(c/2).

In practice, there are electrical and optical delays on the transmission route and the receiving route, wherein the transmission route corresponds to a time period between the transmission of the trigger signal from the synchronization controller 11 to the LD driver 12 and the emission of light by the scanner 14, and wherein the receiving route corresponds to a time period between the incidence of the return light to the scanner 14 and the conversion to the digital signal by the A/D converter 18. Thus, in order to calculate the target distance Ltag from the sample index k, it is necessary to provide an offset (referred to as “origin offset k0”) on the index k and to subtract the origin offset k0 (i.e., 270) from the index k. When further considering the origin offset k0, the target distance Ltag is expressed as

Ltag={(k−k0)/fsmp}·(c/2).

### Detail of Signal Process Unit

### (1) Block Configuration

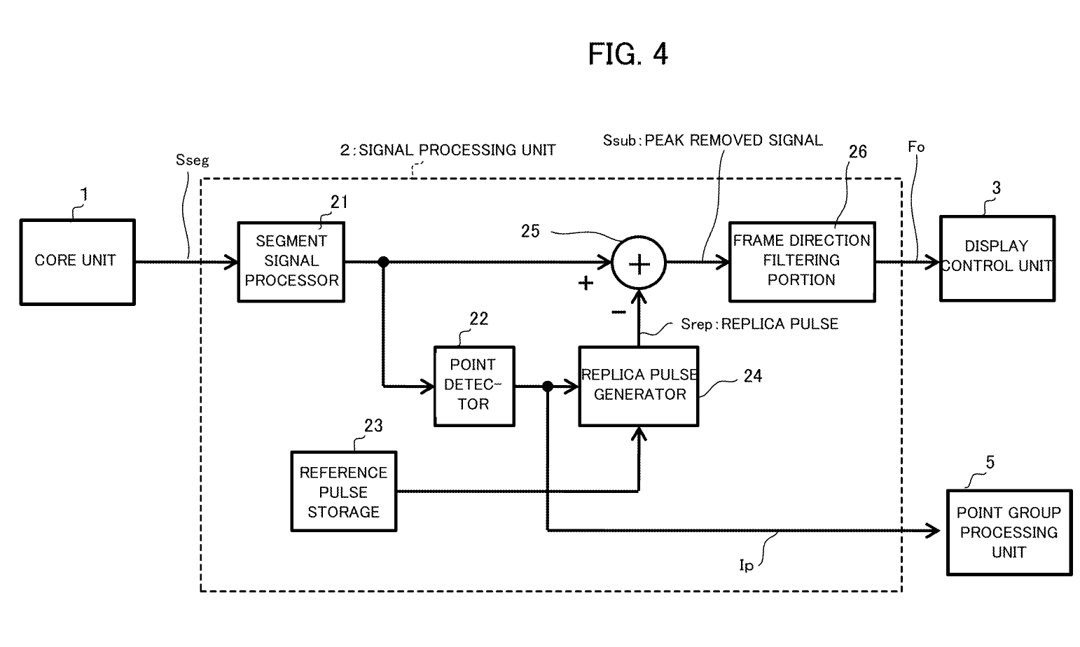

FIG. 4 illustrates a block diagram indicating a logical configuration of the signal processing unit 2. As illustrated in FIG. 4, the signal processing unit 2 includes a segment signal processor 21, a point detector 22, a reference pulse storage 23, a replica pulse generator 24, an operator 25, and a frame direction filtering portion 26.

The segment signal processor 21 processes the segment signal Sseg in order to suppress the noise. For example, the segment signal processor 21 maximizes the signal-to-noise ratio of the segment signal Sseg by applying a matched filter.

The point detector 22 detects a peak of the waveform of the segment signal Sseg after the processing by the segment signal processor 21 and estimates the amplitude (referred to as “amplitude Ap”) at each detected peak and the delay time Td corresponding to the peak. Then, at the time when there is a peak of the wavelength of the segment signal Sseg having the amplitude Ap equal to or larger than a predetermined threshold (referred to as “threshold Apth”), the point detector 22 supplies information on the amplitude Ap and the delay time Td of the peak to the replica pulse generator 24. Additionally, the point detector 22 generates the measurement point information Ip with respect to each peak whose estimated amplitude Ap is equal to or larger than the threshold Apth and supplies them to the point group processing unit 5, wherein the measurement point information Ip indicates a combination of the distance corresponding to the delay time Td and the scan angle corresponding to the target segment. It is noted that the measurement point information Ip may also include the information (i.e., information equivalent to the amplitude Ap) on the received light intensity in addition to the distance corresponding to the delay time Td. In this case, for example, the point group processing unit 5 uses the information on the received light intensity in the measurement point information Ip for the purpose of compartment line detection and the like after applying distance correction to the information and converting the information into the reflection intensity. The threshold Apth is an example of the “predetermined value” according to the present invention and the measurement point information Ip is an example of the “second information” according to the present invention.

The reference pulse storage 23 preliminarily stores a waveform (referred to as “reference pulse”) of the segment signal Sseg at the time when the photo detector 16 ideally receives the reflective light. The reference pulse according to the embodiment indicates a waveform of the segment signal Sseg at the time when the photo detector 16 ideally receives the laser light reflected by an object that is put close to the LIDAR unit 100. For example, the reference pulse is generated in advance through experimental trials. The reference pulse is read out by the replica pulse generator 24.

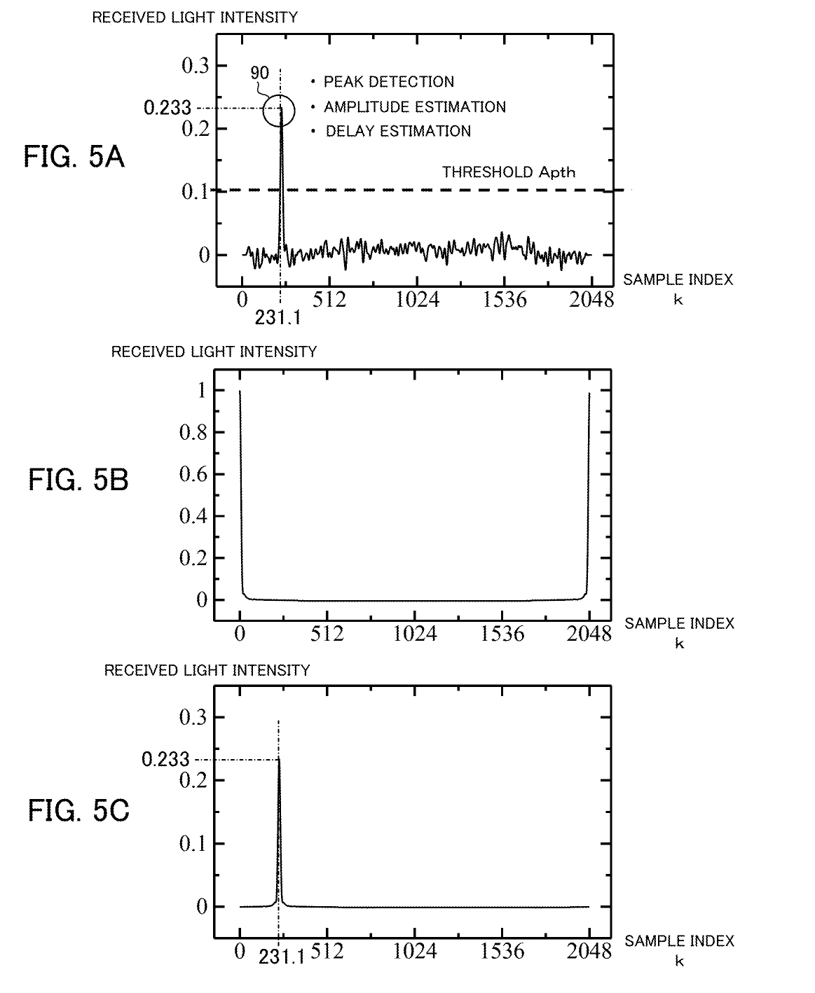

The replica pulse generator 24 generates a signal (referred to as “replica pulse Srep”) that indicates a waveform of a peak detected by the point detector 22. Specifically, on the basis of estimation values of the amplitude Ap and the delay time Td supplied from the point detector 22, the replica pulse generator 24 corrects the reference pulse that is read out from the reference pulse storage 23 to generate the replica pulse Srep. A specific example of the generating method of the replica pulse Srep will be given with reference to FIGS. 5A to 5C. The replica pulse Srep is an example of the “third information” according to the present invention.

The replica pulse generator 24 subtracts the replica pulse Srep from the segment signal Sseg, wherein the replica pulse Srep is supplied from the replica pulse generator 24 and the segment signal Sseg is supplied from the segment signal processor 21. Then, the replica pulse generator 24 supplies the frame direction filtering portion 26 with the segment signal Sseg (referred to as “peak removed signal Ssub”) with the removal of the replica pulse Srep.

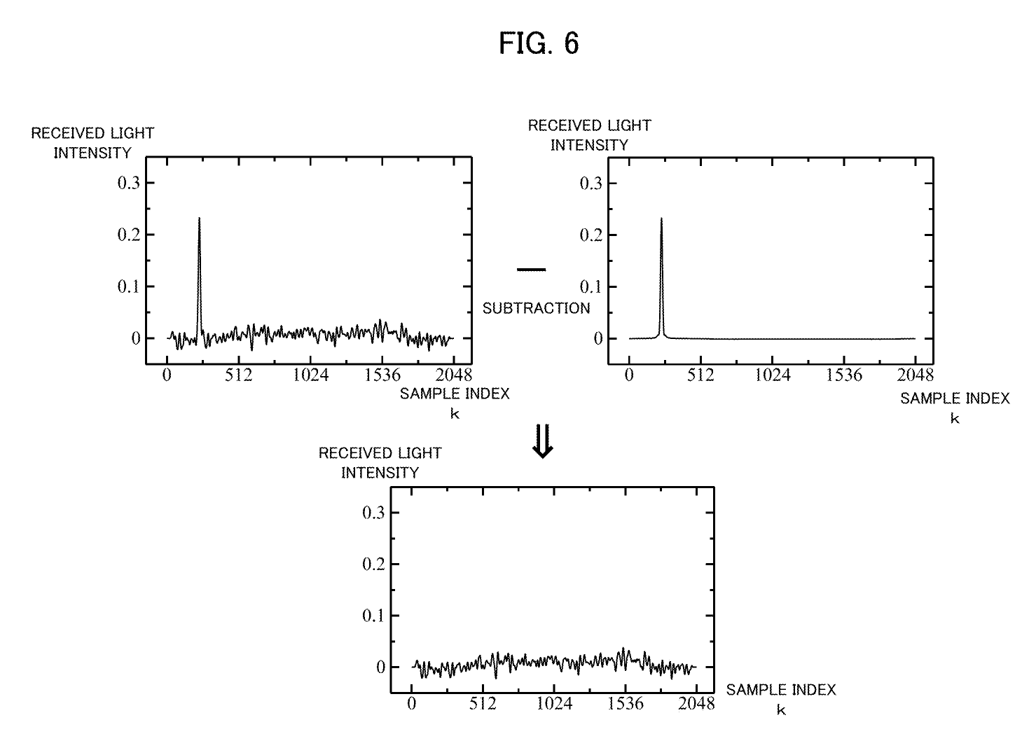

The frame direction filtering portion 26 generates one polar coordinate space frame Fp from peak subtraction signals Ssub extracted from every segment signal Sseg with respect to 900 segments. Furthermore, the frame direction filtering portion 26 generates an orthogonal coordinate space frame Fo by filtering the polar coordinate space frames Fp in the frame direction. A description of the process executed by the frame direction filtering portion 26 will be given with reference to FIG. 6. It is noted that the point detector 22 and the frame direction filtering portion 26 constitutes an example of the “output unit” according to the present invention.

### (2) Generation of Replica Pulse and Subtraction Process

Next, a specific example of the generation process of the replica pulse Srep and the subtraction process of the replica pulse Srep executed by the operator 25 will be given with reference to FIGS. 5A to 5C and FIG. 6.

FIG. 5A illustrates an example of a waveform of the segment signal Sseg outputted by the segment signal processor 21 with respect to a segment. The received light intensity on the vertical axis in FIG. 5A has a value “1” at the time when the photo detector 16 ideally receives the reflective light.

In this case, the point detector 22 detects a peak (see the frame 90) having an amplitude Ap equal to or larger than the threshold Apth and estimates the amplitude Ap of the detected peak as “0.233” and the sample index k corresponding to the delay time Td as “231.1”.

FIG. 5B illustrates an example of a waveform of the reference pulse. In this case, as illustrated in FIG. 5B, the sample index k corresponding to the delay time Td is approximately “0” and the amplitude Ap is “1”. The reference pulse storage 23 preliminarily stores the reference pulse as illustrated in FIG. 5B and supplies it to the replica pulse generator 24.

FIG. 5C illustrates a replica pulse Srep generated based on the amplitude Ap and delay time Td estimated from the segment signal Sseg illustrated in FIG. 5A and the reference pulse illustrated in FIG. 5B. In this case, the replica pulse generator 24 generates the replica pulse Srep illustrated in FIG. 5C by correcting the reference pulse illustrated in FIG. 5B based on the amplitude Ap and the delay time Td estimated in the example illustrated in FIG. 5A. Specifically, the replica pulse generator 24 turns the amplitude Ap of the reference pulse into “0.233” that is the estimation value of the amplitude Ap acquired from the point detector 22 while turning the sample index k at the peak of the reference pulse into “231.1” that is the estimation value of the sample index k acquired from the point detector 22.

FIG. 6 illustrates an overview of the subtraction process of the replica pulse Srep executed by the operator 25. As illustrated in FIG. 6, by subtracting the replica pulse Srep (see the top right of FIG. 6) from the segment signal Sseg (see the top left of FIG. 6), the operator 25 generates the peak removed signal Ssub (see the middle of the bottom of FIG. 6) that is the segment signal Sseg illustrated in FIG. 5A with the removal of the peak having the amplitude Ap equal to or larger than the threshold Apth. In this way, on the basis of the replica pulse Srep, the operator 25 can generate the peak removed signal Ssub that is the segment signal Sseg with the removal of information on the point group detected by the point detector 22.

### (3) Frame Filtering

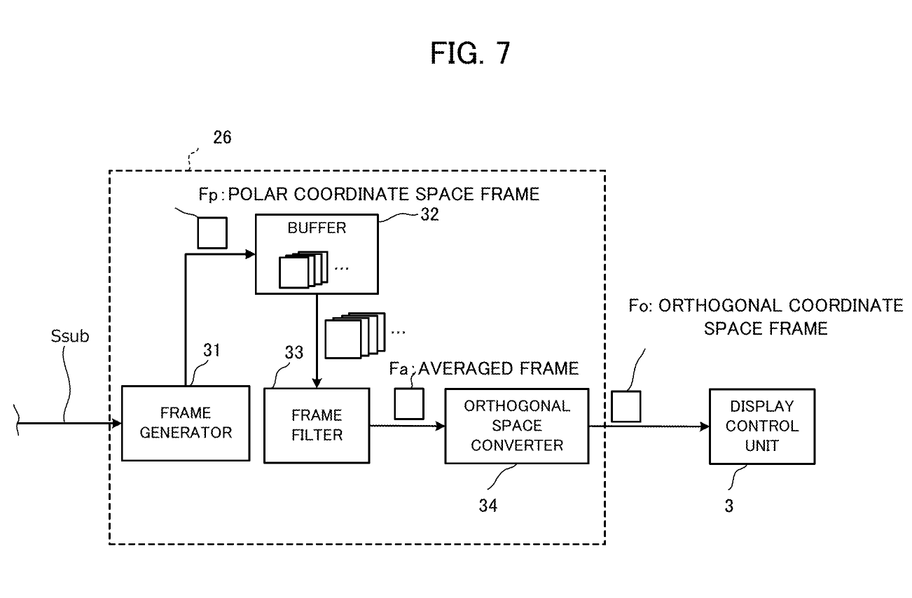

FIG. 7 is a block diagram illustrating the functional configuration of the frame direction filtering portion 26. The frame direction filtering portion 26 mainly includes a frame generator 31, a buffer 32, a frame filter 33 and an orthogonal space converter 34.

The frame generator 31 generates a polar coordinate space frame Fp from peak subtraction signals Ssub extracted from every segment signal Sseg with respect to 900 segments and stores the polar coordinate space frame Fp on the buffer 32. Given that there are 2048 samples per segment and that the number of all segments is 900 according to the embodiment, the frame generator 31 generates an image with 900-by-2048 pixels as a polar coordinate space frame Fp. In this way, at the time of receiving from the operator 25 peak subtraction signals Ssub corresponding to 900 segments with the indexes “k=0” to “k=899”, the frame generator 31 combines the peak subtraction signals into one polar coordinate space frame Fp and stores the polar coordinate space frame Fp on the buffer 32. The coordinate system of the polar coordinate space frame Fp is a polar coordinate system having a vertical axis corresponding to the scan angle (i.e., angle) and a horizontal axis corresponding to the target distance Ltag (i.e., radius). The polar coordinate space frame Fp is an example of the “first information” according to the present invention.

The buffer 32 stores each polar coordinate space frame Fp generated by the frame generator 21 for at least a predetermined time. The above-mentioned predetermined time is determined to have such a length at the shortest that the buffer 32 can store as many polar coordinate space frames Fp as the frame filter 33 needs.

The frame filter 33 extracts a predetermined number (e.g., 16 frames) of time-series polar coordinate space frames Fp from the buffer 32 and applies a frame filtering to them to thereby generate the time-averaged polar coordinate space frame Fp (referred to as “averaged frame Fa”). Thereby, the frame filter 33 generates such an averaged frame Fa that the noise which appears in each polar coordinate space frame Fp is suppressed. In this case, the term “frame filtering” herein includes any processing to reduce the noise by use of time-series polar coordinate space frames Fp. For example, the frame filter 33 may generate the averaged frame Fa by calculating the moving average of a predetermined number of the polar coordinate space frames Fp extracted from the buffer 32 or may generate the averaged frame Fa by applying a first order infinite impulse response filter thereto.

The orthogonal space converter 34 generates an orthogonal coordinate space frame Fo by converting the coordinate system of the averaged frame Fa outputted by the frame filter 33 from a polar coordinate system into an orthogonal (Cartesian) coordinate system. In this case, the orthogonal space converter 34 generates the orthogonal coordinate space frame Fo by specifying pixels of the averaged frame Fa to which each pixel of the orthogonal coordinate space frame Fo corresponds. Then, the orthogonal space converter 34 supplies the generated orthogonal coordinate space frame Fo to the display control unit 3. The orthogonal space converter 34 is an example of the “conversion unit” according to the present invention. The orthogonal coordinate space frame Fo is an example of the “fourth information” according to the present invention.

### (4) Specific Example

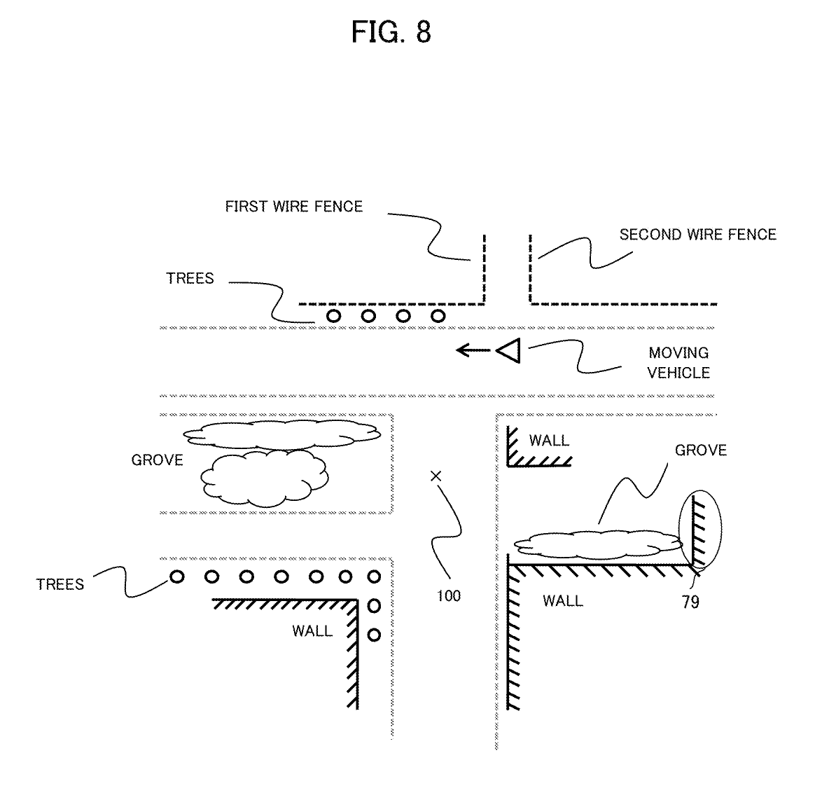

Next, a specific example of the process executed by the signal processing unit 2 will be explained with reference to FIGS. 8 to 12.

FIG. 8 is a plane view schematically illustrating surroundings of the LIDAR unit 100 at the time of an experiment. As illustrated in FIG. 8, in the vicinity of the LIDAR unit 100, as objects, there are mainly walls, trees, groves, a first wire fence, a second wire fence and a moving vehicle. Hereinafter, such a specific case will be given that the signal processing unit 2 processes sixteen frames from zeroth frame to fifteenth frame based on the frame frequency in accordance with the rotational speed of the scanner 14.

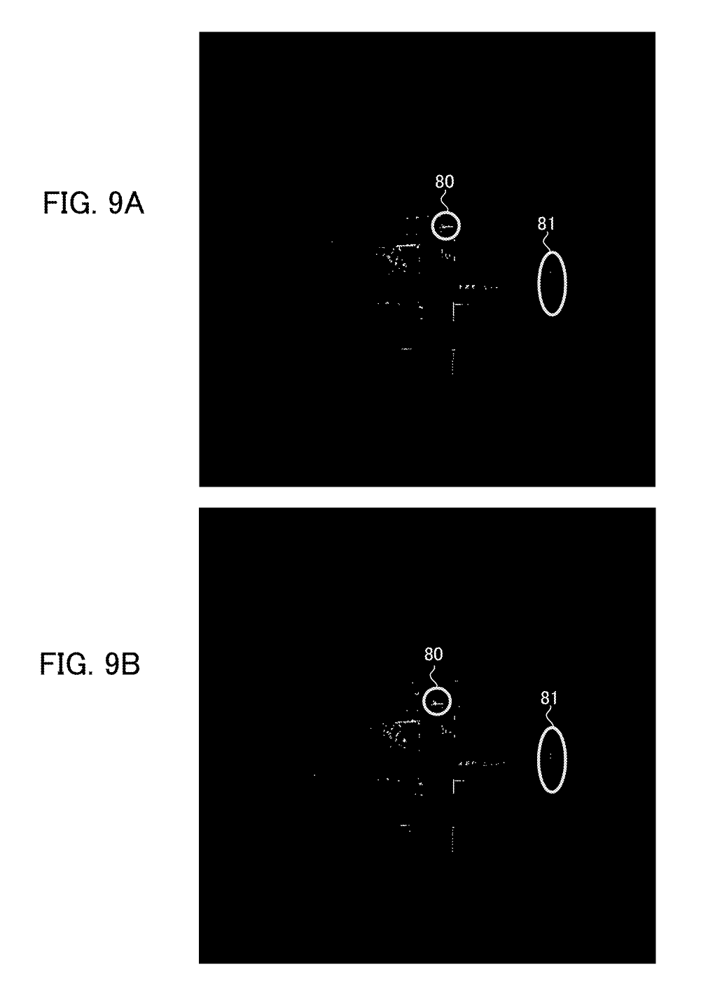

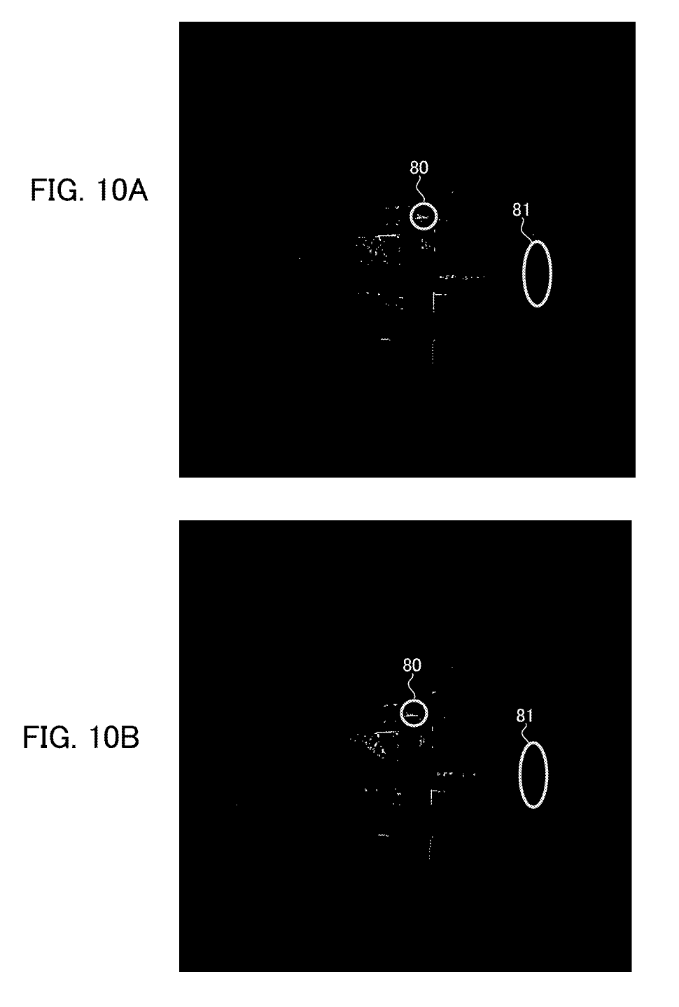

FIG. 9A is a diagram in which the point group detected at the zeroth frame process by the point detector 22 is plotted on the orthogonal coordinate system, and FIG. 9B is a diagram in which the point group detected at the fifth frame process by the point detector 22 is plotted on the orthogonal coordinate system. FIG. 10A is a diagram in which the point group detected at the tenth frame process by the point detector 22 is plotted on the orthogonal coordinate system, and FIG. 10B is a diagram in which the point group detected at the fifteenth frame process by the point detector 22 is plotted on the orthogonal coordinate system. The circle 80 indicates the position of the moving vehicle and the circle 81 indicates the position of the wall in the circle 79 in FIG. 8. It is noted that pixels corresponding to each measurement point are set to white while other pixels are set to black.

In this case, the moving vehicle in the circle 80 is precisely detected since it is situated in the vicinity of the LIDAR unit 100 in either case of FIG. 9A, FIG. 9B, FIG. 10A or FIG. 10B. Due to the movement of moving vehicle, the point group (see the circle 80) corresponding to the moving vehicle moves towards left as the frame number becomes large.

Meanwhile, the wall in the circle 81 cannot be detected as a point group by the point detector 22 since it is situated relatively distant from the LIDAR unit 100 and there is a grove between the LIDAR unit 100 and the wall. Thus, it is impossible to recognize the existence of the wall based on the detection result of the point detector 22.

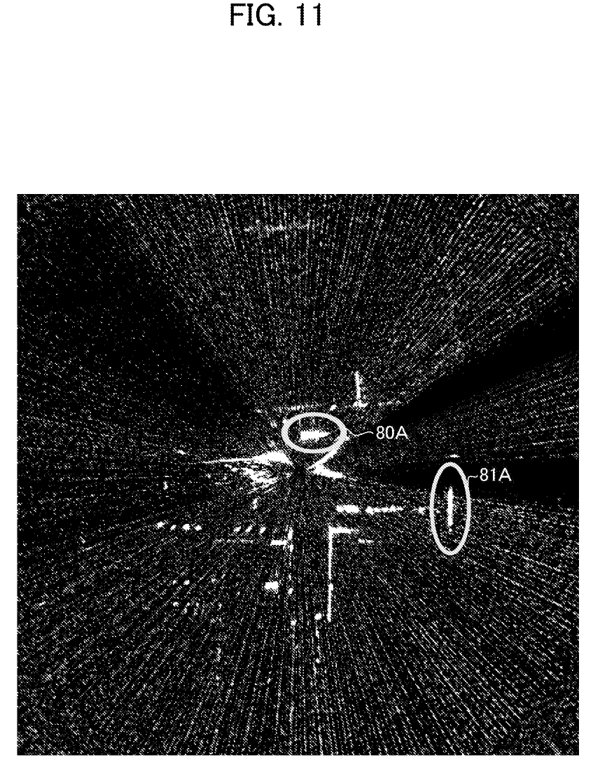

FIG. 11 is a display example of the orthogonal coordinate space frame Fo generated based on such a segment signal Sseg that the subtraction of the replica pulse Srep is not applied. In the example illustrated in FIG. 11, at each of the zeroth to fifteenth frame processes, the frame direction filtering portion 26 generates a polar coordinate space frame Fp based on segment signals Sseg each of which the subtraction of the replica pulse Srep is not applied to. Thereafter, by converting the averaged frame Fa calculated from the generated sixteen polar coordinate space frames Fp into the orthogonal coordinate system, the frame direction filtering portion 26 generates the orthogonal coordinate space frame Fo illustrated in FIG. 11. In FIG. 11, the higher the value (i.e., received light intensity) of the digital signal outputted by the A/D converter 18 is, the closer to white the color of the pixel becomes. The circle 80A herein indicates the position of the moving vehicle and the circle 81A indicates the position of the wall in the circle 79 in FIG. 8.

Through the averaging process of the sixteen frames, the orthogonal coordinate space frame Fo illustrated in FIG. 11 displays relatively distant objects including the wall (see circle 81A) which does not appear in any of frames illustrated in FIGS. 9A to 10B. In contrast, an area with the high received light intensity corresponding to the moving vehicle forms a line along the moving trajectory during the measurement period. In this way, if the subtraction of the replica pulse Srep is not applied, a point group of a moving object forms a line along the moving trajectory on the orthogonal coordinate space frame Fo and the moving object is detected as an object having a longer shape in the moving direction than the real shape of the moving object.

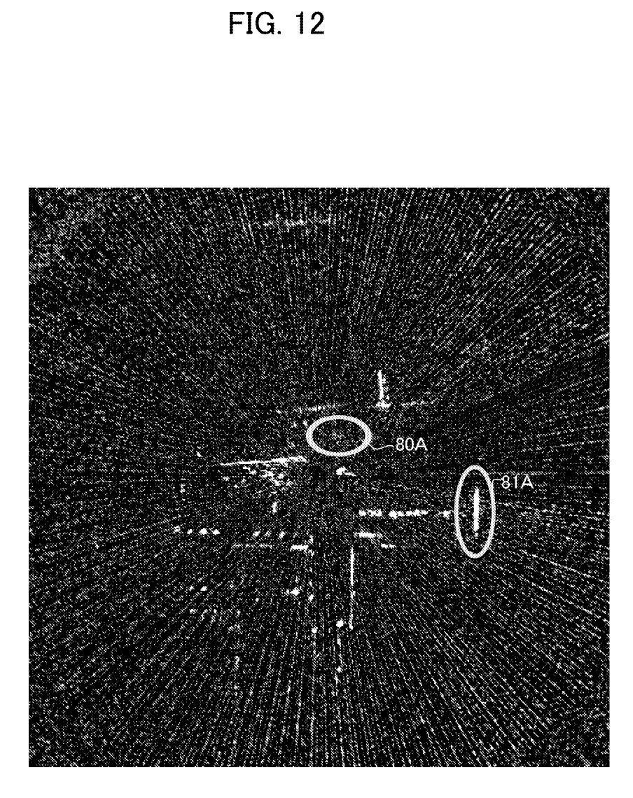

FIG. 12 is a display example of the orthogonal coordinate space frame Fo according to the embodiment, wherein the orthogonal coordinate space frame Fo is generated based on the peak removed signal Ssub after the subtraction of the replica pulse Srep. In this case, information on point groups, including the point group corresponding to the moving body, which appear on each frame illustrated in FIGS. 9A to 10B are removed. In contrast, in the same way as the orthogonal coordinate space frame Fo illustrated in FIG. 11, the orthogonal coordinate space frame Fo illustrated in FIG. 12 displays relatively distant objects including the wall (see circle 81A) which does not appear in any of frames illustrated in FIGS. 9A to 10B. In this way, through the subtraction of the replica pulse Srep, the LIDAR unit 100 can suitably display, on the orthogonal coordinate space frame Fo, relatively distant objects which the point detector 22 cannot detect. It is noted that even if there is a moving distant object which the point detector 22 cannot detect as a point group, the length of the line along the moving trajectory can be assumed to be short with acceptable level. This is because the moving distance of the moving distant object on the orthogonal coordinate space frame Fo is likely to be shorter than any moving nearby object which the point detector 22 can detect.

As described above, on the basis of a segment signal Sseg outputted by a core unit 1, a signal processing unit 2 of a LIDAR unit 100 generates a polar coordinate space frame Fp indicating the received light intensity of laser light with respect to each scan angle that indicates the outgoing direction of the laser light and its corresponding target distance Ltag. Then, the signal processing unit 2 converts the polar coordinate space frames Fp into an orthogonal coordinate space frame Fo and outputs it to a display control unit 3. Further, for an outgoing direction of the laser light in which the segment signal Sseg outputted by the core unit 1 indicates a received light intensity equal to or larger than a threshold Apth, the signal processing unit 2 generates the measurement point information Ip and outputs it to a point group processing unit 5. According to this mode, the LIDAR unit 100 can display relatively distant object(s) on the orthogonal coordinate space frame Fo while outputting point groups of relatively near object (s) as the measurement point information Ip. In other words, on the assumption that the LIDAR unit 100 is mounted on a vehicle for the purpose of the surrounding environment recognition, the LIDAR unit 100 can promptly detect relatively near object(s) (e.g., other moving objects) by processing their point groups while the LIDAR unit 100 can precisely detect distant object(s) by averaging time-series orthogonal coordinate space frames.

[Modifications]

Next, a description will be given of preferred modifications of the embodiment. The following modifications may be applied to the above embodiment in any combination.

(First Modification)

Generally, when a multipath occurs due to partial irradiation of the laser light onto an object, there can be cases where the segment signal Sseg corresponding to one segment has multiple peaks that are equal to or larger than the threshold Apth. In these cases, the signal processing unit 2 may repeatedly do subtraction process by use of the replica pulse Srep until the peak removed signal Ssub has no peak that is equal to or larger than the threshold Apth.

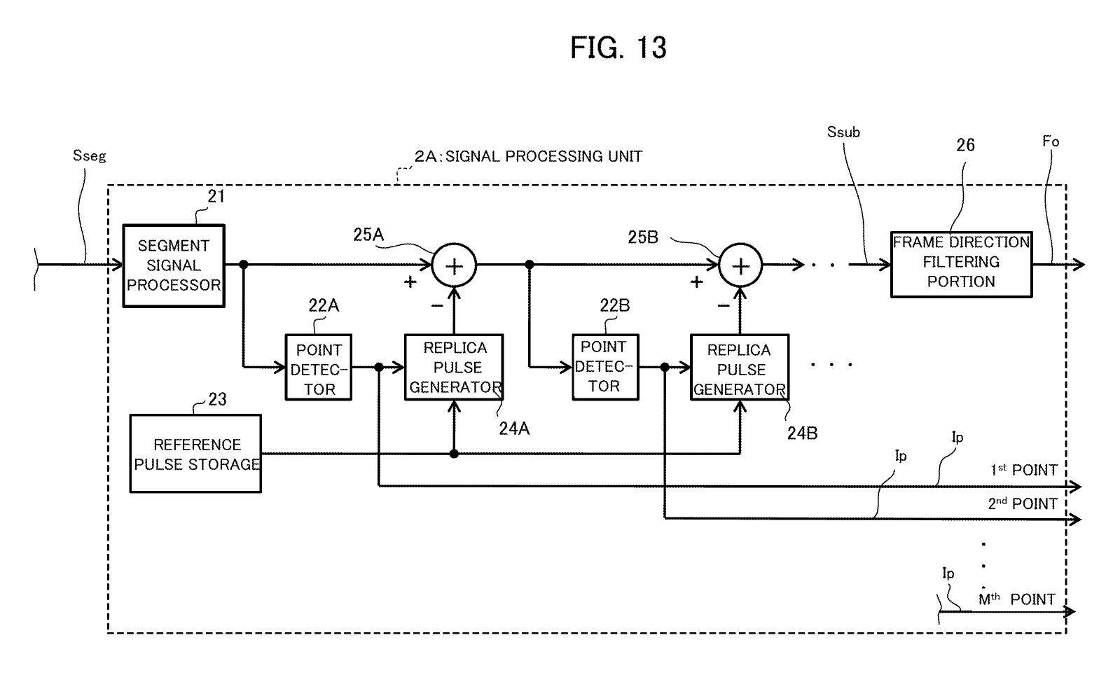

FIG. 13 illustrates a block configuration of the signal processing unit 2A according to the present modification. The signal processing unit 2A illustrated in FIG. 13 includes multiple point detectors 22 (22A, 22B, . . . ), multiple replica pulse generators 24 (24A, 24B, . . . ) and multiple operators 25 (25A, 25B, . . . ).

The point detector 22A detects, from the segment signal Sseg outputted by the segment signal processor 21, the peak having the largest amplitude Ap. Then, at the time when the amplitude Ap of the detected peak is equal to or larger than the threshold Apth, the point detector 22A supplies the point group processing unit 5 with the measurement point information Ip corresponding to the detected peak while supplying the replica pulse generator 24A with the amplitude Ap of the detected peak and the sample index k corresponding to the delay time Td. Thereafter, the replica pulse generator 24A generates the replica pulse Srep based on the amplitude Ap and the sample index k which are supplied from point detector 22A and the operator 25A subtracts the replica pulse Srep generated by the replica pulse generator 24A from the segment signal Sseg outputted by the segment signal processor 21.

In the same way, the point detector 22B detects the peak having the largest amplitude Ap from the segment signal Sseg outputted by the operator 25A. Then, at the time when the amplitude Ap of the detected peak is equal to or larger than the threshold Apth, the point detector 22A supplies the replica pulse generator 24B with the amplitude Ap of the detected peak and the sample index k corresponding to the delay time Td while supplying the point group processing unit 5 with the measurement point information Ip corresponding to the detected peak. Thereafter, the replica pulse generator 24B generates the replica pulse Srep based on the amplitude Ap and the sample index k which are supplied from point detector 22B and the operator 25B subtracts the replica pulse Srep generated by the replica pulse generator 24B from the segment signal Sseg outputted by the operator 25A. It is noted that, at the time when the amplitude Ap of the detected peak is smaller than the threshold Apth, the point detector 22B inputs the signal outputted by the operator 25A to the frame direction filtering portion 26 as the peak removed signal Ssub without letting the replica pulse generator 24B generate the replica pulse Srep.

As described above, according to the configuration illustrated in FIG. 13, the signal processing unit 2A can detect multiple measurement points from one segment. Thus, while supplying the measurement point information Ip relating to the detected multiple measurement points to the point group processing unit 5, the signal processing unit 2A can generate the orthogonal coordinate space frame Fo by generating the peak removed signal Ssub that is free from the information relating to the detected multiple measurement points.

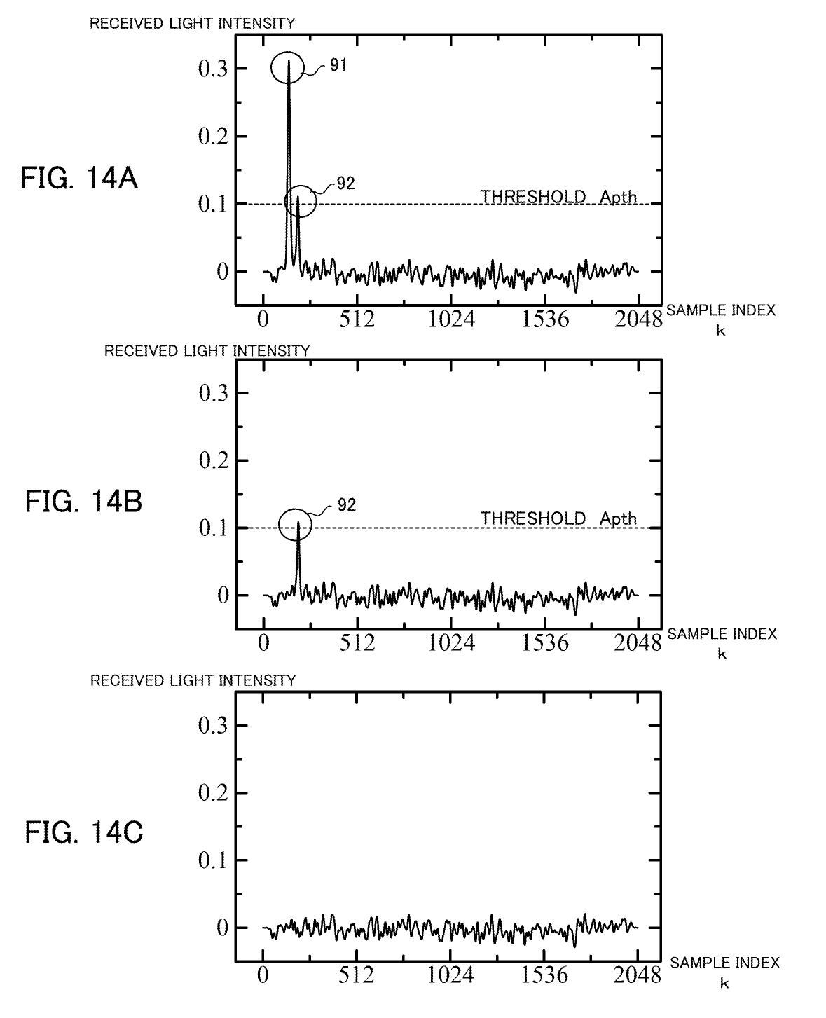

FIG. 14(A) illustrates an example of a waveform of the segment signal Sseg outputted by the segment signal processor 21 at a segment. In this example, due to the occurrence of a multipath of the laser light, there are two peaks having the amplitude Ap equal to or larger than the threshold Apth. In this case, the point detector 22A firstly detects the peak (see the circle 91) having the largest amplitude Ap and then supplies the replica pulse generator 24A with the amplitude Ap and sample index k corresponding to the delay time Td with respect to the peak. Thereby, the replica pulse generator 24A generates the replica pulse Srep.

FIG. 14B illustrates the waveform of the segment signal Sseg after the operator 25A subtracting the replica pulse Srep which the replica pulse generator 24A generates. The waveform illustrated in FIG. 14B does not have the peak in the circle 91 in FIG. 14A. Then, the point detector 22B detects the peak (see the circle 92) having the largest amplitude Ap from the signal illustrated in FIG. 14B and supplies the replica pulse generator 24B with the amplitude Ap and the sample index k corresponding to the delay time Td with respect to the detected peak. Thereby, the replica pulse generator 24B generates the replica pulse Srep.

FIG. 14C illustrates a waveform of the signal outputted by the operator 25B. As illustrated in FIG. 14C, by subtracting the replica pulse Srep that the replica pulse generator 24B generates from the signal outputted by the operator 25A, the operator 25B removes the peak in the circle 92. The signal illustrated in FIG. 14C is inputted to the frame direction filtering portion 26 as the peak removed signal Ssub. Thereby, the peak removed signal Ssub in which there is no peak having an amplitude Ap equal to or larger than the threshold Apth is suitably generated.

(Second Modification)

The configuration of the LIDAR unit 100 is not limited to the configuration illustrated in FIG. 1.

For example, the LIDAR unit 100 does not necessarily have to have the display control unit 3 and the display 4. In this case, for example, by applying an image recognition process to the orthogonal coordinate space frame Fo which the signal processing unit 2 generates, the LIDAR unit 100 detects an object and informs the user of the existence of the object by an audio output device. In another example, the LIDAR unit 100 may stores, on a storage unit, the orthogonal coordinate space frame Fo generated by the signal processing unit 2 together with the present position information of the LIDAR unit 100 acquired from a GPS receiver.

The LIDAR unit 100 may generate the measurement point information Ip by the point detector 22 and the orthogonal coordinate space frame Fo by the frame direction filtering portion 26 per layer by repeating the horizontal scanning by the scanner 14 with respect to multiple layers arranged in the vertical direction.

(Third Modification)

The configuration of the core unit 1 illustrated in FIG. 2 is an example and the configuration to which the present invention can be applied is not limited to the configuration illustrated in FIG. 2. For example, the laser diode 13 and the motor control unit 15 may be configured to revolve together with the scanner 14.

(Fourth Modification)

The LIDAR unit 100 may generate the orthogonal coordinate space frame Fo based on the segment signal Sseg to which the subtraction of the replica pulse Srep does not applied and display on the display 4.

In this case, the frame direction filtering portion 26 firstly generates polar coordinate space frames Fp based on the segment signal Sseg without subtraction of the replica pulse Srep and then converts the averaged frame Fa calculated from the polar coordinate space frames Fp into the orthogonal coordinate system to generate the orthogonal coordinate space frame Fo.

(Fifth Modification)

In such a case that the LIDAR unit 100 is mounted on a vehicle, the LIDAR unit 100 determines whether or not the vehicle on which the LIDAR unit 100 is mounted stops. Then, the LIDAR unit 100 executes the process by the reference pulse storage 23 only if the LIDAR unit 100 determines that the vehicle stops. In this case, at the time when the vehicle moves, the LIDAR unit 100 generates the orthogonal coordinate space frame Fo by converting the polar coordinate space frame Fp into the orthogonal coordinate system. Thereby, it is possible to prevent the lines along the moving trajectory from being displayed on the orthogonal coordinate space frame Fo.

In another example, in accordance with the moving speed of the vehicle, the LIDAR unit 100 may determine the number (i.e., depth of the filter) of the polar coordinate space frames Fp to be used for generating the orthogonal coordinate space frame Fo, in other words, determine the time length of averaging time-series polar coordinate space frames Fp. In this case, with reference to a predetermined map and the like, the higher the moving speed of the vehicle is, the less number of the polar coordinate space frames Fp to be used for generating the orthogonal coordinate space frame Fo the reference pulse storage 23 determines. The above-mentioned map is a map which defines the relationship between the speed of the vehicle and a parameter for determining the number of the polar coordinate space frames Fp to be used for generating the orthogonal coordinate space frame Fo. For example, the map is preliminarily provided through experimental trials. Even in this example, it is possible to suppress the lines along the moving trajectory from being displayed on the orthogonal coordinate space frame Fo.

It is noted that, since LIDAR unit 100 according to the above-mentioned section (Fourth Modification) does not do the subtraction of the replica pulse Srep, the point group of any nearby object which relatively moves with respect to the LIDAR unit 100 is displayed on the orthogonal coordinate space frame Fo in the form of the lines along the moving trajectory. Thus, this modification is suitable to combine with the fourth modification.

### BRIEF DESCRIPTION OF REFERENCE NUMBERS

1 Core unit
2 and 2A Signal processing unit
3 Display control unit
4 Display
5 Point group processing unit
100 LIDAR unit

1. An information processing device comprising:
an emitting unit configured to emit laser light while changing an outgoing direction of the laser light;
a light receiving unit configured to receive the laser light reflected by an object; and
an output unit configured, on a basis of a light receiving signal outputted by the light receiving unit, to
(i) generate and output fist information which indicates received light intensity of the laser light
with respect to each of the outgoing direction and distance, in the corresponding outgoing direction, from a reference position relating to an emitting position, and
(ii) generate and output, in the outgoing direction that the light receiving signal indicates a received light intensity equal to or higher than a predetermined value, second information which indicates distance to the object.

2. The information processing device according to claim 1,
wherein the output unit is configured to output time-averaged first information based on multiple pieces of the first information generated for a predetermined time length.

3. The information processing device according to claim 1,
wherein the output unit is configured to generate third information from the light receiving signal in the outgoing direction that the second information is generated, and
wherein the output unit is configured to generate the first information by subtracting a signal component of the third information from the light receiving signal outputted by the light receiving unit.

4. The information processing device according to claim 3,
wherein the output unit is configured, with respect to each of the outgoing direction, to generate, as the third information, a signal having a peak with the same position and amplitude as a waveform of the light receiving signal in the outgoing direction that the second information is generated, the peak having an amplitude equal to or larger than the predetermined value, and
wherein the output unit is configured to subtract the signal component of the third information from the light receiving signal in the corresponding outgoing direction.

5. The information processing device according to claim 4,
wherein, in a case where the waveform of the light receiving signal in the corresponding outgoing direction has multiple peaks each having an amplitude equal to or larger than the predetermined value, the output unit generates the third information with respect to each of the peaks and subtracts each signal component of the third information from the light receiving signal in the corresponding outgoing direction.

6. The information processing device according to claim 1, further comprising
a conversion unit configured to convert the first information outputted by the output unit to fourth information which indicates the received light intensity in an orthogonal coordinate system corresponding to a plane irradiated with the laser light.

7. The information processing device according to claim 6,
wherein the fourth information indicates the received light intensity in a two dimensional space which is parallel to a horizontal plane, and the information processing device further comprising
a display control unit configured to display an image based on the fourth information on a display unit.

8. A control method executed by an information processing device, the information processing device including an emitting unit and a light receiving unit, the emitting unit configured to emit laser light while changing an outgoing direction of the laser light, the light receiving unit configured to receive the laser light reflected by an object, the control method comprising
(i) generating and outputting first information which indicates received light intensity of the laser light based on a light receiving signal outputted by the light receiving unit
with respect to each of the outgoing direction and distance, in the corresponding outgoing direction, from a reference position relating to an emitting position, and
(ii) generating and outputting, in the outgoing direction that the light receiving signal indicates a received light intensity equal to or higher than a predetermined value, second information which indicates distance to the object based on the light receiving signal.

9. A non-transitory computer readable medium including instructions executed by a computer of an information processing device, the information processing device including an emitting unit and a light receiving unit, the emitting unit configured to emit laser light while changing an outgoing direction of the laser light, the light receiving unit configured to receive the laser light reflected by an object, the instructions comprising
(i) generating and outputting first information which indicates received light intensity of the laser light based on a light receiving signal outputted by the light receiving unit
with respect to each of the outgoing direction and distance, in the corresponding outgoing direction, from a reference position relating to an emitting position, and
(ii) generating and outputting, in the outgoing direction that the light receiving signal indicates a received light intensity equal to or higher than a predetermined value, second information which indicates distance to the object based on the light receiving signal.

10. (canceled)
